(19) United States
(12) Patent Application Publication
(10) Pub. No.: US 2017/0257706 A1
(43) Pub. Date: Sep. 7, 2017

(54) SOUND GENERATING UNIT AND ELECTRONIC DEVICE

(71) Applicant: TOKIN CORPORATION, Sendai-shi, Miyagi (JP)

(72) Inventors: Osamu YAMAZAKI, Sendai-shi (JP); Noriaki IKEZAWA, Sendai-shi (JP); Yoshiyuki ABE, Sendai-shi (JP); Koichi SHUTA, Sendai-shi (JP); Katsunori KUMASAKA, Sendai-shi (JP); Masafumi KATSUNO, Sendai-shi (JP)

(73) Assignee: TOKIN CORPORATION, Sendai-shi, Miyagi (JP)

(21) Appl. No.: 15/528,507

(22) PCT Filed: Nov. 17, 2015
(86) PCT No.: PCT/JP2015/082251

§ 371 Date: May 20, 2017

(30) Foreign Application Priority Data
Nov. 21, 2014 (JP) 2014-236679
May 28, 2015 (JP) 2015-108493

(51) Int. Cl. H04R 17/00; H04R 1/02; H04R 7/04

(52) U.S. Cl. CPC H04R 17/00; H04R 7/04; H04R 1/028; H04R 2499/11

(57) ABSTRACT

An electronic device is provided with a main surface member which is used as a vibrating plate, a case which supports the main surface member and a sound generating unit which is attached to the case to generate sound by vibrating the main surface member. The sound generating unit is provided with a piezoelectric plate and a protective member. The piezoelectric plate has a longitudinal direction in a first horizontal direction and has an upper surface, a lower surface and a plurality of side surfaces. The protective member has a supporting portion covering the lower surface of the piezoelectric plate and supporting the piezoelectric plate, a protective portion provided to the supporting portion to cover at least one of the side surfaces of the piezoelectric plate and an attached portion attached to the case.

### TECHNICAL FIELD

This invention relates to a sound generating unit which is attached in an electronic device to generate sound.

### BACKGROUND ART

Patent Document 1 discloses a piezoelectric actuator usable as a sound generating unit of this type. The piezoelectric actuator is provided with a piezoelectric ceramic vibrator, a holder which is attached on a resilient body (an object to be vibrated) and which holds an end of the resilient body and a supplemental holder which is provided between a lower portion of the piezoelectric ceramic vibrator and the resilient body.

### PRIOR ART DOCUMENTS

### Patent Document(s)

Patent Document 1: International Publication No. 2007/102305

### SUMMARY OF INVENTION

### Technical Problem

There is a need for generating sound by vibrating a glass plate (panel) which forms a screen in an electronic device such as a mobile phone, a tablet device or a personal computer (PC). In a case of trying to respond to this need, the piezoelectric actuator of Patent Document 1 would be attached to the glass plate. In such an electronic device, due to its structure, there is a possibility that a piezoelectric ceramic vibrator is damaged when shock such as fall of the electronic device is given on the piezoelectric ceramic vibrator.

Especially in a case where the electronic device is provided with a supplemental holder, when the piezoelectric actuator is bent by giving the shock such as fall thereon, stress is concentrated in a piezoelectric ceramic, and the piezoelectric ceramic vibrator is easily damaged.

Therefore, an object of the present invention is providing a sound generating unit which can be built in an electronic device and which has good frequency characteristics of sound pressure and vibration transmission and which has a shock-proof structure.

### Solution to Problem

One aspect of the present invention provides a sound generating unit, as a first sound generating unit, that is used in an electronic device provided with a main surface member used as a vibrating plate and a case supporting the main surface member and that is attached to either the main surface member or the case to generate sound by vibrating the main surface member. The sound generating unit is provided with a piezoelectric plate and a protective member. The piezoelectric plate has a longitudinal direction in a first horizontal direction and has an upper surface, a lower surface and a plurality of side surfaces. The protective member has a supporting portion which covers the lower surface of the piezoelectric plate and which supports the piezoelectric plate, a protective portion which is provided to the supporting portion to cover at least one of the side surfaces and an attached portion which is attached to either the main surface member or the case.

Furthermore, another aspect of the present invention provides an electronic device, as a first electronic device, that is provided with the first sound generating unit, the main surface member and the case. The sound generating unit is attached to either the main surface member or the case.

### Advantageous Effects of Invention

According to the present invention, the protective member covers a whole area of the lower surface of the piezoelectric plate and covers at least one of the side surfaces of the piezoelectric plate. Therefore, it is possible to prevent the piezoelectric plate from being damaged by shock such as fall of the electronic device.

At the same time, the protective member may have any structure and any shape provided that it covers the lower surface and at least one of the side surfaces of the piezoelectric plate. Accordingly, structure and shapes of the supporting portion and the protective portion can be devised diversely. Hence, it is possible to obtain a sound generating unit which excels in flatness of frequency characteristics of sound pressure and vibration transmission and in which it is easy to control resonant frequencies of a plurality of resonant vibration modes in spite of a small and thin body thereof.

An appreciation of the objectives of the present invention and a more complete understanding of its structure may be had by studying the following description of the preferred embodiments and by referring to the accompanying drawings.

### BRIEF DESCRIPTION OF DRAWINGS

FIG. 1 is a perspective view showing an electronic device according to a first embodiment of the present invention.

FIG. 2 is a cross-sectional view showing a part of the electronic device of FIG. 1, taken along A-A line.

FIG. 3 is a perspective view showing a sound generating unit and a part of a case which are included in the electronic device of FIG. 2.

FIG. 4 is a diagram showing a frequency characteristic of sound pressure in the electronic device including the sound generating unit of FIG. 3.

FIG. 5 is a perspective view showing a sound generating unit and a part of a case which are included in an electronic device according to a second embodiment of the present invention.

FIG. 6 is a perspective view showing a sound generating unit and a part of a case which are included in an electronic device according to a third embodiment of the present invention.

FIG. 7 is a perspective view showing a sound generating unit and a part of a case which are included in an electronic device according to a forth embodiment of the present invention.

FIG. 8 is a diagram showing a frequency characteristic of sound pressure in the electronic device including the sound generating unit of FIG. 7.

FIG. 9 is a cross-sectional view showing a modified example of the sound generating unit of FIG. 7 and corresponding to a cross section taken along B-B line of FIG. 7.

FIG. 10 is a perspective view showing a modified example of the electronic device of FIG. 5.

FIG. 11 is a perspective view showing a modified example of the electronic device of FIG. 10.

### DESCRIPTION OF EMBODIMENTS

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### First Embodiment

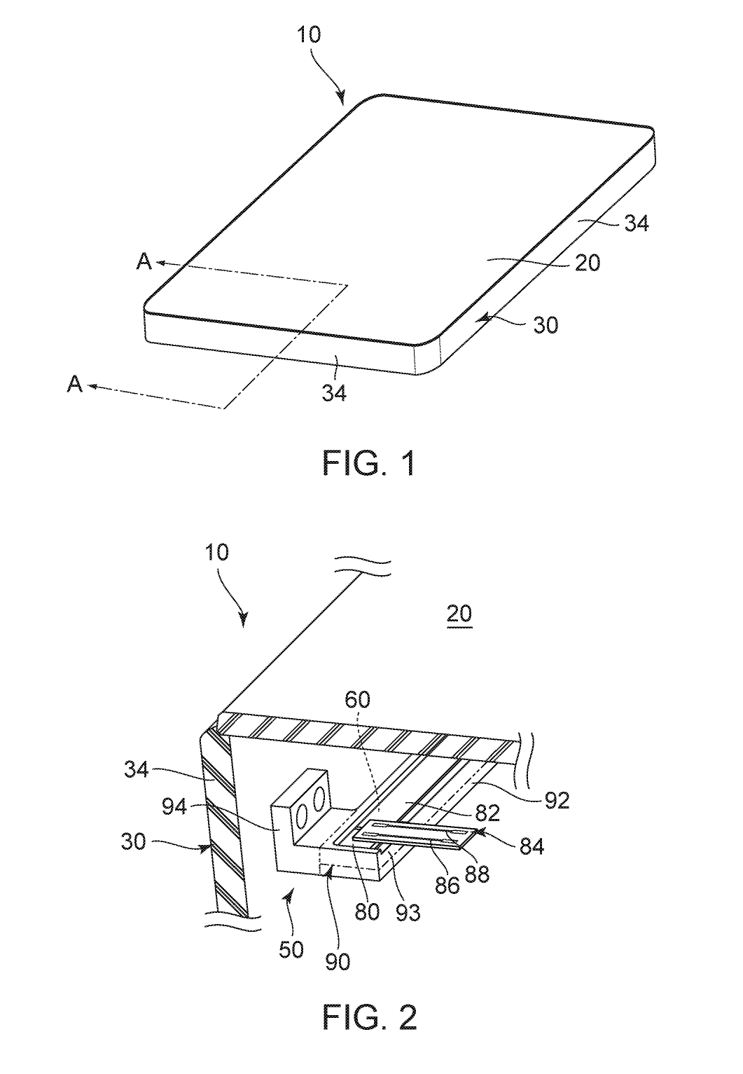

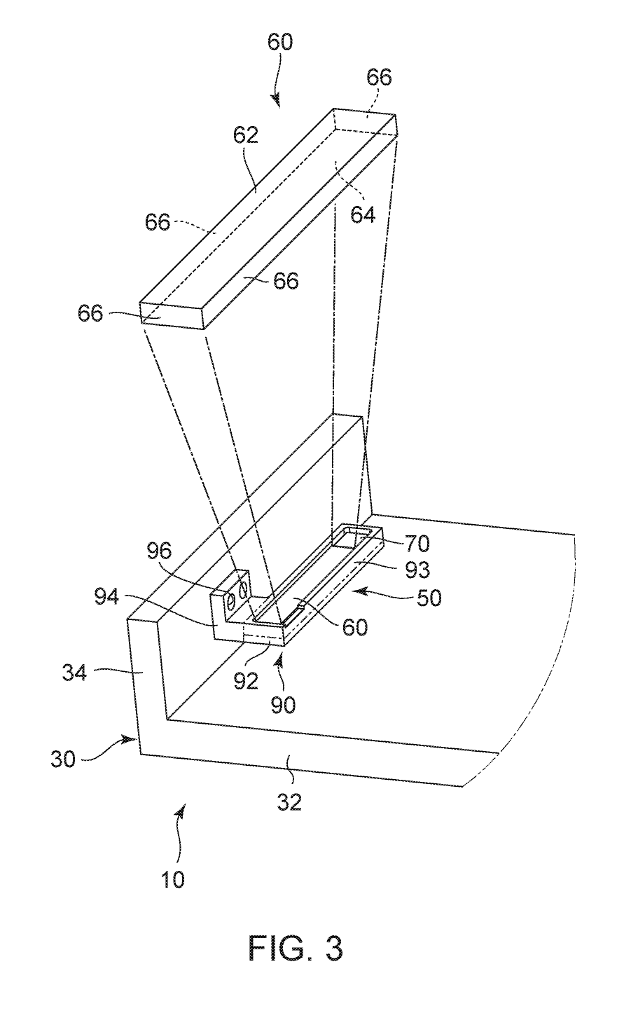

Referring to FIGS. 1 and 2, an electronic device 10 according to a first embodiment of the present invention is provided with a main surface member 20 which is used as a vibrating plate, a case 30 which supports the main surface member 20 and a sound generating unit 50 which is attached to either the main surface member 20 or the case 30. For example, the electronic device 10 of the present embodiment is a mobile phone, a tablet device, a personal computer (PC) or the like, and the main surface member 20 is a glass plate (panel) forming a screen of the electronic device 10. In the present embodiment, the main surface member 20 is disposed to be parallel to a horizontal plane.

Referring to FIG. 3, the case 30 of the present embodiment has a bottom portion 32 and sidewall portions 34 extending upward from the bottom portion 32. As understood from FIGS. 1 and 2, the sidewall portions 34 support the main surface member 20.

As understood from FIG. 2, the sound generating unit 50 is disposed in a space formed by the main surface member 20 and the case 30. The sound generating unit 50 is attached to either the main surface member 20 or the case 30 in the interior of the electronic device 10 and generates sound by vibrating the main surface member 20. The sound generating unit 50 of the present embodiment is attached to the sidewall portion 34 of the case 30 and vibrates the main surface member 20 by vibrating the sidewall portion 34. It should be noted that at least a vertical direction is included in vibration directions of the sidewall portion 34. Accordingly, the main surface member 20 can be vibrated in the vertical direction.

As shown in FIG. 3, the sound generating unit 50 of the present embodiment is provided with a piezoelectric plate 60, a protective member 90 and a weight 70.

Referring to FIG. 3, the piezoelectric plate 60 of the present embodiment has an upper surface 62, a lower surface 64 and a plurality of side surfaces 66.

The piezoelectric plate 60 illustrated has a longitudinal direction in a first horizontal direction. That is, in the present embodiment, the longitudinal direction of the piezoelectric plate 60 is the first horizontal direction. As understood from FIGS. 2 and 3, on the upper surface 62 of the piezoelectric plate 60, two external electrodes 80 and 82 are formed. To the external electrodes 80 and 82, an electric signal (driving voltage) is supplied through conductors 86 and 88 formed on a flexible printed circuit (FPC) 84. The piezoelectric plate 60 is vibrated according to the electric signal supplied thereto. In accordance with this, the sound generating unit 50 performs bending motion including an amplitude in the vertical direction perpendicular to the main surface member 20.

As shown in FIG. 3, the weight 70 is for adjusting a frequency characteristic of sound pressure. Although the weight 70 is not limited in material, it is preferable that the weight 70 is small for downsizing of the electronic device 10. Accordingly, it is preferable that the weight 70 is made of a material having high specific gravity. In the present embodiment, the weight 70 is made of tungsten. In the sound generating unit 50 illustrated, the weight 70 provided is one in number. However, the present invention is not limited thereto. The number of the weights 70 may be two or more.

As shown in FIG. 3, the protective member 90 has a supporting portion (bottom portion) 92 of a flat plate shape which supports the piezoelectric plate 60, a protective portion (side portion) 93 of a frame shape which is formed along edges of the supporting portion 92 to protrude upward and an attached portion 94 which is attached to either the main surface member 20 or the case 30. In FIG. 3, boundaries among the supporting portion 92, the protective portion 93 and the attached portion 94 are shown by chain double-dashed lines (imaginary lines). In the present embodiment, the supporting portion 92, the protective portion 93 and the attached portion 94 are formed in a single body using identical material. The protective member 90 of the present embodiment is made of fiber reinforced plastic, which is raw material having restoring force against bending. In more detail, the protective member 90 is made of glass fiber reinforced polyamide resin. However, the protective member 90 may be made of any other material provided that it meets requirements of the present invention. For example, a metal plate such as a stainless steel (SUS) may be used in a case of improving vibration characteristics of vibration other than sound vibration (vibrator vibration, about 200-220 Hz) or in a case where a high mechanical quality factor (Qm) is allowed. In a case where cost and fabrication easiness are given priority, it is preferable that the protective member 90 is made of resin like the present embodiment.

The supporting portion 92 covers the lower surface 64 of the piezoelectric plate 60, and the protective portion 93 covers at least one of the side surfaces 66 of the piezoelectric plate 60. Accordingly, positioning of the piezoelectric plate 60 with respect to the supporting portion 92 becomes easy. Moreover, even when the sound generating unit 50 is downsized with a reduction of the electronic device 10 in thickness, good frequency characteristics can be obtained. In detail, thickness of the supporting portion 92 (the bottom portion or a part supporting the lower surface 64 of the piezoelectric plate 60) should be reduced to downsize the sound generating unit 50. However, when the thickness of the supporting portion 92 is reduced, there is a possibility that a resonant frequency is reduced and sound characteristics in a high frequency band deteriorate. Even in such a case, by providing the protective portion 93 (the side portion), which covers at least a part of the side surfaces 66 of the piezoelectric plate 60, on the supporting portion 92, the resonant frequency can be shifted to a higher frequency side, and deterioration of the sound characteristics in the high frequency band can be prevented.

In the present embodiment, the supporting portion 92 supports the lower surface 64 of the piezoelectric plate 60, and the protective portion 93 surrounds the plurality of the side surfaces 66 in the horizontal plane parallel to the lower surface 64. In the structure that the protective portion 93 covers the plurality of the side surfaces 66 of the piezoelectric plate 60, frequency characteristics can be adjusted by selecting length and height of the protective portion 93, a position where the protective portion 93 is disposed or the like.

In more detail, the supporting portion 92 illustrated covers the whole of the lower surface 64 of the piezoelectric plate 60. Furthermore, the protective portion 93 covers three of the side surfaces 66 in the horizontal plane. There may be or not may be a gap between the protective portion 93 and the piezoelectric plate 60. The protective portion 93 has a size (thickness) larger than a size of the piezoelectric plate 60 in a direction perpendicular to the lower surface 64. Hence, the protective portion 93 covers the whole of each of the three side surfaces 66 to prevent the piezoelectric plate 60 from hitting directly against any other member (e.g. the main surface member 20). However, the protective portion 93 may have the size smaller than the size of the piezoelectric plate 60 in the direction perpendicular to the lower surface 64. The remaining one of the side surfaces 66 of the piezoelectric plate 60 is covered by the weight 70. The protective portion 93 surrounds both of the piezoelectric plate 60 and the weight 70 in the horizontal plane. Moreover, the supporting portion 92 and the protective portion 93 hold the weight 70 and the piezoelectric plate 60 in a state that the weight 70 and the piezoelectric plate 60 are aligned with each other in the first horizontal direction. As understood from this, the supporting portion 92 and the protective portion 93 of the present embodiment form a tub-shape structure body of a rectangular shape which has the bottom portion (the supporting portion 92) and the side portion (the protective portion 93) rising from the bottom portion to surround all sides. The piezoelectric plate 60 and the weight 70 are accommodated and held by the tub-shape structure body consisting of the supporting portion 92 and the protective portion 93 in a state that the upper surface 62 is exposed. Holding the piezoelectric plate 60 and the weight 70 the supporting portion 92 and the protective portion 93 can be executed using an adhesive or a double-faced tape. In terms of reliability, it is preferable to use the adhesive. Since the supporting portion 92 and the protective portion 93 form the tub-shape structure body, they have an advantage that resin can be embedded in the interior of them and thereby the frequency characteristics can be adjusted. Additionally, the supporting portion 92 according to the present embodiment has a cross section of a rectangular shape in a plane orthogonal to the first horizontal direction. However, the present invention is not limited thereto. The supporting portion 92 may have various shapes. Moreover, the weight 70 may be embedded in either one or both of the supporting portion 92 and the protective portion 93 at least in part. In the present embodiment, the weight 70 is provided at one, which is farther from the attached portion 94, of two end portions of the supporting portion 92 in the first horizontal direction. However, the present invention is not limited thereto. The weight 70 may be provided at the other, which is nearer from the attached portion 94, of the end portions of the supporting portion 92 or at a position apart from the two end portions.

The attached portion 94 extends in a second horizontal direction orthogonal to the first horizontal direction from the supporting portion 92 and the protective portion 93. That is, the attached portion 94 protrudes from the supporting portion 92 and the protective portion 93 along a short direction of the piezoelectric plate 60. Accordingly, when the protective member 90 of the present embodiment is seen along the vertical direction (or in a plan view), the attached portion 94 does not overlap with the supporting portion 92 and the protective portion 93.

The protective member 90 according to the present embodiment has an L-shape when seen along the vertical direction. That is, the protective member 90 of the present embodiment has an L-shape in a plan view. However, the present invention is not limited thereto. The protective member 90 may have a broad T-shape, for example.

The attached portion 94 is attached to the sidewall portion 34 of the case 30. That is, the protective member 90 is attached to the case 30 only by the attached portion 94, and nothing for suppressing vibration of the supporting portion 92 (and the protective portion 93) lies between the supporting portion 92 (and the protective portion 93) and the case 30.

In detail, the protective member 90 is attached to the case 30 only at one end of the L-shape in a plan view. In the circumstances that only one end of the protective member 90 having the L-shape is connected to the case 30 like this, a plurality of resonant points is generated when the piezoelectric plate 60 is vibrated. Accordingly, sound having good frequency characteristics with less bias depending frequency can be generated.

The attached portion 94 of the present embodiment is formed with screw holes 96, and the attached portion 94 is screwed on the sidewall portion 34 of the case 30. The attached portion 94 may be screwed on any other part of either the main surface member 20 or the case 30. Furthermore, the attached portion 94 may be attached to either the main surface member 20 or the case 30 using an adhesive, or it may be attached to either the main surface member 20 or the case 30 using any other means such as ultrasonic fusion, press-fitting or fitting-in.

In more detail, the attached portion 94 of the present embodiment has an L-shaped cross section in a plane defined by the vertical direction and the second horizontal direction. That is, the attached portion 94 has a first part protruding from the supporting portion 92 in the second horizontal direction and a second part rising from the first part in the vertical direction. In a plane defined by the vertical direction and the first horizontal direction, the second part has an area larger than that of the first part. Consequently, the attached portion 94 can be attached to the sidewall portion 34 of the case 30 using a larger area.

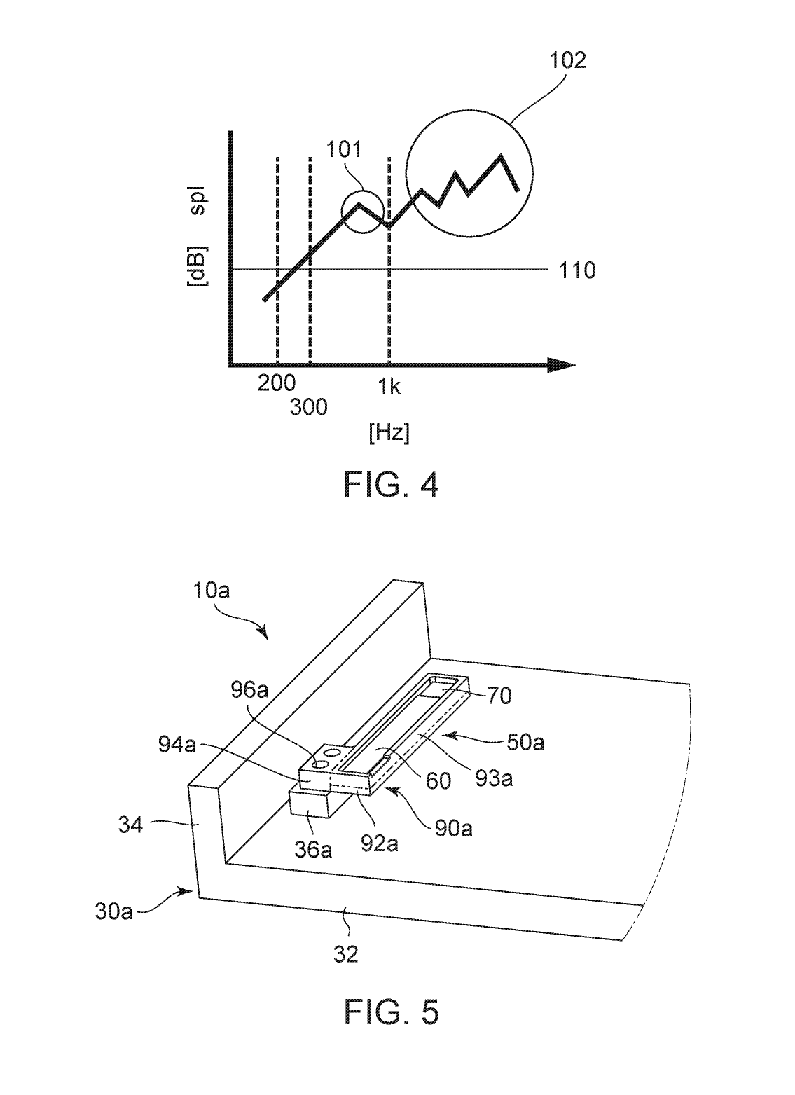

FIG. 4 shows the frequency characteristic of the sound pressure of the electronic device 10 according to the present embodiment. In FIG. 4, a horizontal axis represents a frequency of the electric signal supplied to the piezoelectric plate 60, and a vertical axis represents a sound pressure level (spl) generated from the main surface member 20. Moreover, in FIG. 4, a necessary sound pressure in a case of use as a receiver speaker of a mobile phone is shown as a sound pressure level 110.

In a basic resonant vibration mode of the sound generating unit 50 (i.e. a mode in which the frequency is lowest among a plurality of resonant vibration modes that the sound generating unit 50 possesses), a part in a vicinity of the weight 70 becomes a loop, and a part in a vicinity of the attached portion 94 becomes a node. In this mode, the piezoelectric plate 60 is bent in the vertical direction perpendicular to the main surface member 20.

At the resonant frequency of the basic resonant vibration mode, a peak 101 appears in the frequency characteristic of the sound pressure. This peak 101 heightens the sound pressure at frequencies lower than 1 kHz. In addition, for example, by increasing mass of the weight 70, the resonant frequency of the basic resonant vibration mode of the sound generating unit 50 can be lowered, and the frequency at which the peak 101 appears in the frequency characteristic can be lowered. It should be noted that the peaks 102 are derived from frequencies of other resonant vibration modes of the sound generating unit 50, resonant frequencies of the main surface member 20 or the like.

In the present embodiment, the mass of the weight 70 is adjusted so as to generate the necessary sound pressure at 300 Hz or more, for example.

### Second Embodiment

Referring to FIG. 5, an electronic device 10a according to a second embodiment of the present invention is a modification of the electronic device 10 according to the first embodiment shown in FIGS. 1 and 2 and is provided with the same structure as that of the first embodiment except for a structure of a case 30a and a structure of a protective member 90a of a sound generating unit 50a. Accordingly, the description will be mainly made to the case 30a and the protective member 90a in the following.

As understood from FIG. 5, in addition to the bottom portion 32 and the sidewall portions 34, the case 30a has a mount 36a protruding upward from the bottom portion 32 at a position apart from the sidewall portions 34.

Similar to the protective member 90 (see FIG. 3), the protective member 90a has a supporting portion 92a and a protective portion 93a, which form a tub-shape structure body, and an attached portion 94a protruding from the supporting portion 92a and the protective portion 93a in the second horizontal direction. The protective member 90a according to the present embodiment has an L-shape when seen along the vertical direction. The attached portion 94a of the present embodiment has a small rectangular parallelepiped shape and is attached to the mount 36a of the case 30a.

Although the mount 36a is provided on the case 30a in the present embodiment, the mount 36a may be formed on the main surface member 20, and the attached portion 94a may be attached to the mount 36a.

### Third Embodiment

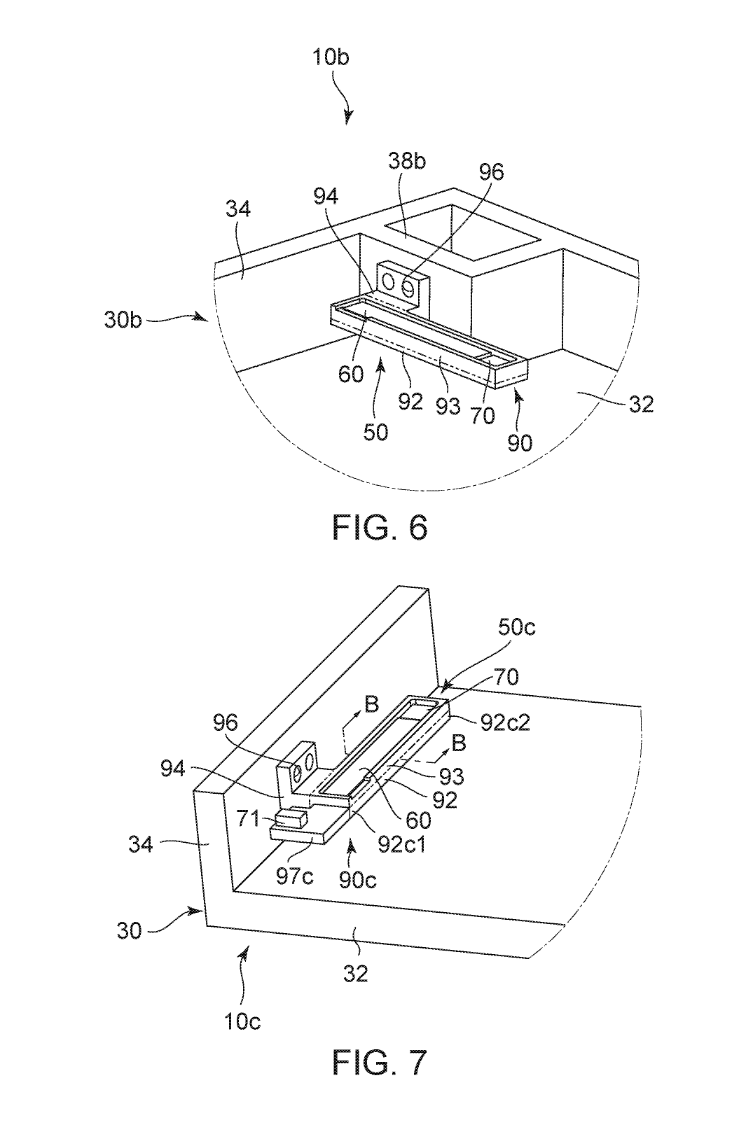

Referring to FIG. 6, an electronic device 10b according to a third embodiment of the present invention is a modification of the electronic device 10 according to the first embodiment shown in FIGS. 1 and 2 and is similar to the first embodiment except for a structure of a case 30b and attachment of the sound generating unit 50 to the case 30b. Accordingly, the description will be mainly made to the case 30b and the attachment of the sound generating unit 50 to the case 30b in the following.

As shown in FIG. 6, in addition to the bottom portion 32 and the sidewall portions 34, the case 30b has an inner structure portion 38b connected to the bottom portion 32 and the sidewall portions 34. The inner structure portion 38b illustrated is provided in a vicinity of a boundary between two of the sidewall portions 34, connects the two sidewall portions 34 to each other in the interior of the case 30b and is also connected to the bottom portion 32 of the case 30b. In detail, the inner structure portion 38b has inner walls which project into the case 30b from the sidewall portions 34. However, the present invention is not limited thereto. The shape of the inner structure portion 38b is not specifically limited but may be any shape provided that the attached portion 94 can be attached thereon.

The attached portion 94 is attached to the inner structure portion 38b. The protective member 90 of the present embodiment is the same as that of the first embodiment. Accordingly, in the present embodiment, the attached portion 94 can be attached to the inner wall of the inner structure portion 38b using the larger area.

### Fourth Embodiment

Referring to FIG. 7, an electronic device 10c according to a fourth embodiment of the present invention is a modification of the electronic device 10 according to the first embodiment shown in FIGS. 1 and 2 and is provided with the same structure as that of the first embodiment except for a structure of a sound generating unit 50c. Accordingly, the description will be mainly made to the sound generating unit 50c in the following.

As shown in FIG. 7, the sound generating unit 50c of the present embodiment is provided with the piezoelectric plate 60, two weights 70 and 71 and a protective member 90c. The piezoelectric plate 60 is the same as that of the first embodiment.

In addition to the supporting portion 92, the protective portion 93 and the attached portion 94 which are of the first embodiment mentioned above, the protective member 90c further has an additional vibrating portion 97c. In detail, the supporting portion 92 supports the piezoelectric plate 60 and the weight 70 as mentioned above. This supporting portion 92 has a first end portion 92c1 and a second end portion 92c2 in the first horizontal direction. The piezoelectric plate 60 is supported by the supporting portion 92 so as to extend toward the second end portion 92c2 from a vicinity of the first end portion 92c1 in the first horizontal direction. The attached portion 94 is positioned at a side of the first end portion 92c1 in the first horizontal direction. The additional vibrating portion 97c further extends from the first end portion 92c1 of the supporting portion 92 in the first horizontal direction. The additional vibrating portion 97c of the present embodiment is formed in a single body with the supporting portion 92 and the protective portion 93 using identical material. However, the present invention is not limited thereto. The additional vibrating portion 97c may be formed to be different and distinct from the supporting portion 92 and attached to the supporting portion 92. The piezoelectric plate 60 according to the present embodiment is not supported by the additional vibrating portion 97c. That is, the piezoelectric plate 60 is supported only by the supporting portion 92. The weight 70 is positioned in a vicinity of the second end portion 92c2 of the supporting portion 92, and the weight 71 is positioned in a vicinity of an end of the additional vibrating portion 97c.

In a basic resonant vibration mode of the sound generating unit 50c having a structure like this (i.e. a mode in which the frequency is lowest among a plurality of resonant vibration modes that the sound generating unit 50c possesses), a part in a vicinity of the weight 70 and a part in a vicinity of the weight 71 become loops, and a part in a vicinity of the attached portion 94 becomes a node. In this mode, the piezoelectric plate 60 is bent in the vertical direction perpendicular to the main surface member 20 (see FIG. 2). In detail, the part in the vicinity of the weight 70 and the part in the vicinity of the weight 71 are vibrated in opposite phases. In other words, when one of them is displaced to get near the main surface member 20, the other is displaced to move away from the main surface member 20.

In addition, since the sound generating unit 50c of the present embodiment is provided with the weight 71 to the additional vibrating portion 97c, it has another resonant vibration mode (hereinafter referred to as “a second resonant vibration mode”) with a resonant frequency equal to a frequency which is relatively near the resonant frequency of the basic vibration mode. In the second resonant vibration mode, similar to in the basic resonant vibration mode, the part in the vicinity of the weight 70 and the part in the vicinity of the weight 71 become loops, and the part in the vicinity of the attached portion 94 becomes a node.

Moreover, the piezoelectric plate 60 is bent in the vertical direction perpendicular to the main surface member 20 (see FIG. 2). On the other hand, the part in the vicinity of the weight 70 and the part in the vicinity of the weight 71 are vibrated in phase. That is, when the part in the vicinity of the weight 70 is displaced to get near the main surface member 20, the part in the vicinity of the weight 71 is also displaced to get near the main surface member 20. When the part in the vicinity of the weight 70 is displaced to move away from the main surface member 20, the part in the vicinity of the weight 71 is also displaced to move away from the main surface member 20.

It should be noted that the resonant frequency of the basic resonant vibrating mode and the resonant frequency of the second resonant vibrating mode can be individually controlled by appropriately selecting mass and positions of the weight 70 and the weight 71, a shape of the supporting portion 92, the protective portion 93 or the additional vibrating portion 97c and the like.

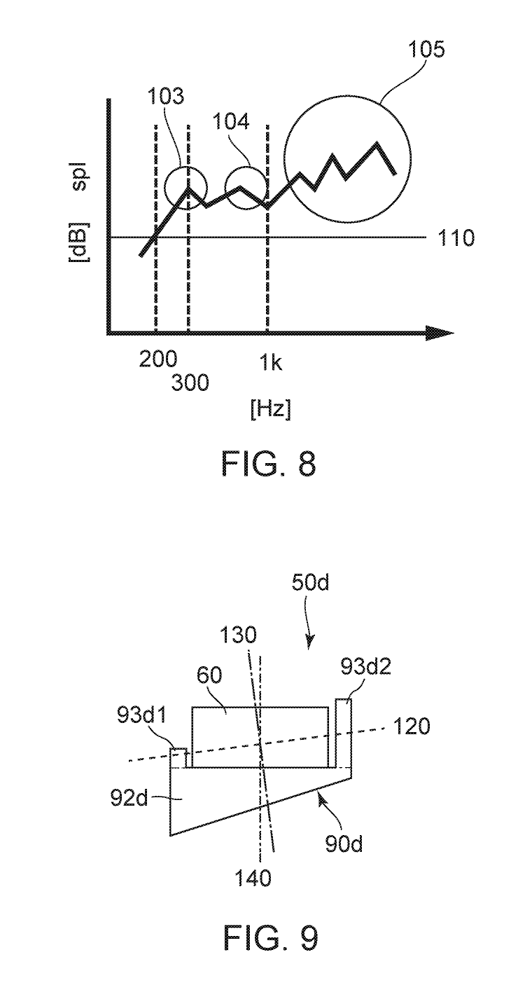

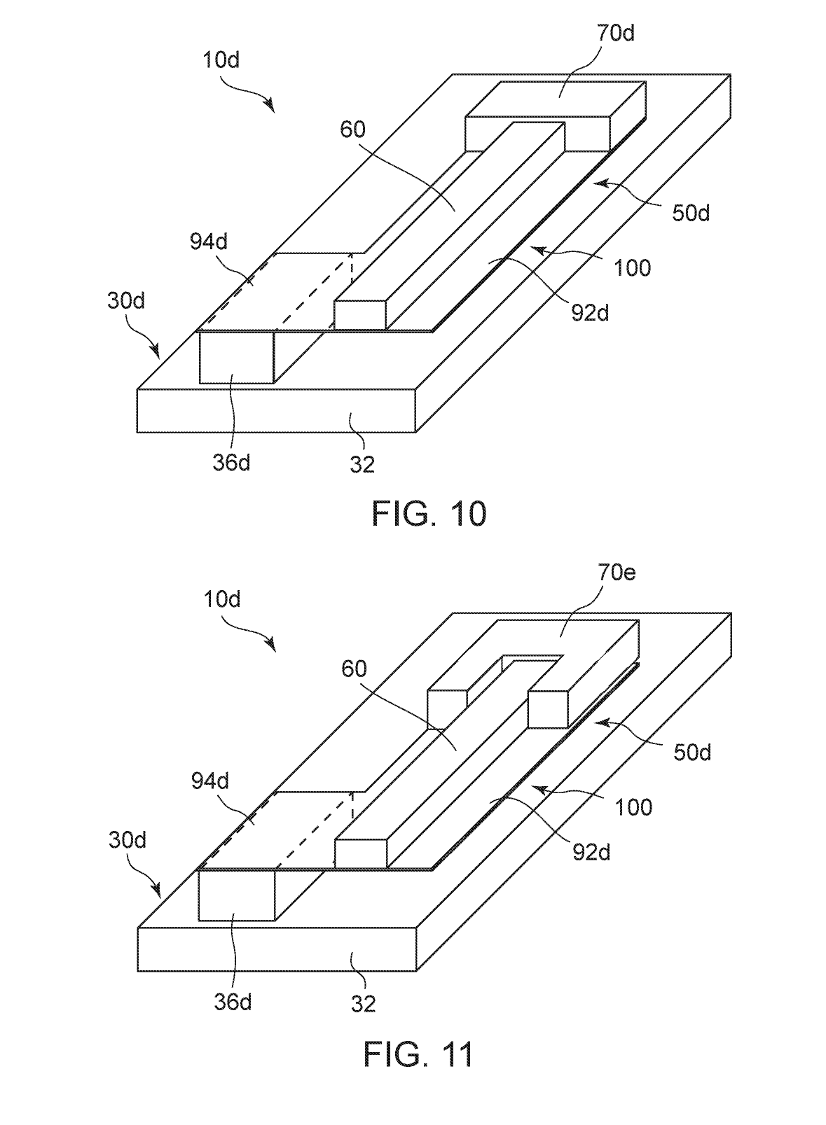

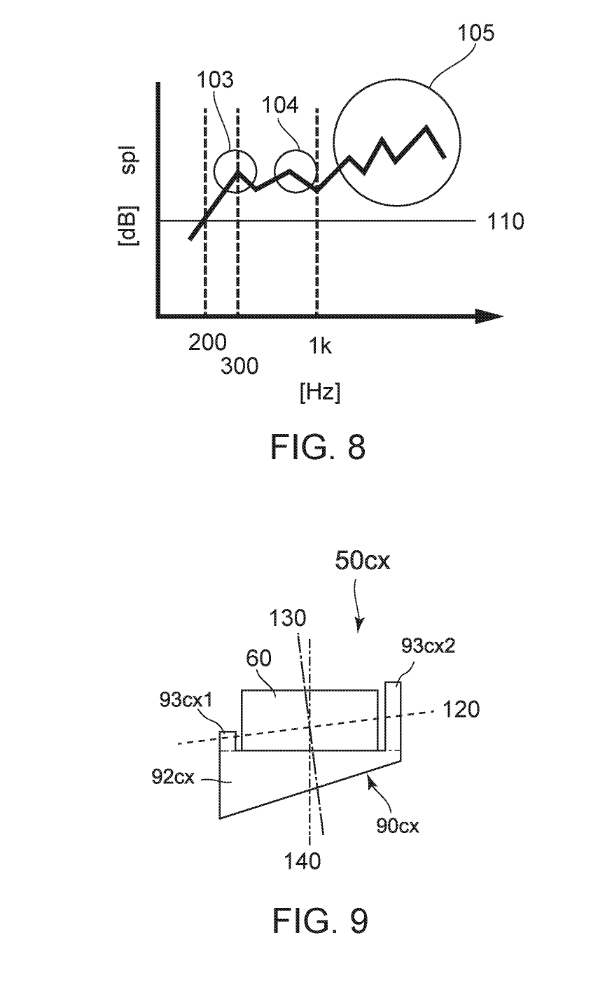

FIG. 8 shows a frequency characteristic of sound pressure of the electronic device 10c according to the present embodiment. In FIG. 8, a horizontal axis represents a frequency of an electric signal supplied to the piezoelectric plate 60, and a vertical axis represents a sound pressure level (spl) generated from the main surface member 20. Moreover, in FIG. 8, a necessary sound pressure in a case of use as a receiver speaker of a mobile phone is shown as a sound pressure level 110.

At the resonant frequency of the basic resonant vibration mode, a peak 103 appears in the frequency characteristic of the sound pressure. In addition, at the resonant frequency of the second resonant vibration mode, a peak 104 appears in the frequency characteristic of the sound pressure. Each of the frequency at which the peak 103 appears (the resonant frequency of the basic resonant vibration mode) and the frequency at which the peak 104 appears (the resonant frequency of the second resonant vibration mode) is lower than 1 kHz. Furthermore, the frequency at which the peak 103 appears (the resonant frequency of the basic resonant vibration mode) and the frequency at which the peak 104 appears (the resonant frequency of the second resonant vibration mode) are relatively near to each other. Hence, according to the present embodiment, a flat frequency characteristic can be obtained in a band under 1 kHz in regard to the sound pressure. In addition, necessary sound pressure can be generated at about 200 Hz or more by adjusting mass of the weight 70 and the weight 71. That is, according to the present embodiment, the necessary sound pressure can be generated in a relatively wide band from a lower frequency side. It should be noted that, in FIG. 8, peaks 105 are derived from frequencies of remaining resonant vibration modes of the sound generating unit 50c, resonant frequencies of the main surface member 20 or the like.

The supporting portion 92 according to the present embodiment has a cross section of a rectangular shape in a plane orthogonal to the first horizontal direction. However, the present invention is not limited thereto. For example, as shown in FIG. 9, a supporting portion 92cx according to a modification has an asymmetrical shape with respect to a straight line 140 which passes through a middle of the second horizontal direction of the supporting portion 92cx and extends in the vertical direction orthogonal to both of the first horizontal direction and the second horizontal direction. In detail, a cross-sectional shape of the supporting portion 92cx is a trapezoid. The protective member 90cx of the modification has a protective portion 93cx1 and a protective portion 93cx2 which are different from each other in height according to the cross-sectional shape of the supporting portion 92cx. However, the protective portion 93cx1 and the protective portion 93cx2 may be of the same height.

In the case where the supporting portion 92cx has the asymmetrical shape as just described, a direction of bending motion of the piezoelectric plate 60 is not limited in a direction of force caused in the piezoelectric plate 60 by supplying the electric signal. At a frequency of a proper resonant vibration mode of a sound generating unit 50cx, the piezoelectric plate 60 begins bending vibration in a direction of the resonant vibration mode. Specifically, the piezoelectric plate 60 is bent and vibrated in a direction 130 which has a predetermined angle with respect to the vertical direction orthogonal to the main surface member 20 (see FIG. 2).

As well known, in a proper resonant vibration mode of an object, a resonant vibration mode exists in a direction perpendicular thereto. That is, the resonant vibration mode in which the piezoelectric plate 60 is vibrated in a direction 120 orthogonal to the direction 130 also exists.

In the case where the supporting portion 92 has a symmetrical structure like the aforementioned embodiment, the resonant vibration mode in which the piezoelectric plate 60 is vibrated in the direction perpendicular to the main surface member 20 and the resonant vibration mode in which the piezoelectric plate 60 is vibrated in a direction (horizontal direction) parallel to the main surface member 20 exist. However, in the resonant vibration mode of the horizontal direction, sound cannot be generated from the main surface member 20.

On the other hand, in the case where the supporting portion 92 has an asymmetrical structure like the supporting portion 92cx, each of the two resonant vibration modes has a vibration component in the direction perpendicular to the main surface member 20. Accordingly, each of the two resonant vibration modes can generate sound from the main surface member 20.

In a case where, for example, each of the two resonant vibration modes orthogonal to each other provides vibration in a direction forming an angle of 45 degrees with the direction perpendicular to the main surface member 20, vibration transmission efficiency roughly calculated is equal to cos 45° (about 0.707). The sound pressure merely decreases by 3 dB. On the other hand, since the two resonant vibration modes exist, sound pressure peaks corresponding to those modes appear in the frequency characteristic of the sound pressure of the sound generating unit. In the case where the supporting portion 92 has the symmetric structure like the aforementioned embodiment, a sound pressure peak with a vibration transmission efficiency of 100% appears at one frequency (see FIG. 4). By contrast, in the case where each of the two resonant vibration modes provides the vibration in the direction forming the angle of 45 degrees with the vertical direction, two sound pressure peaks with vibration efficiency of about 70% appear. Consequently, a more flat frequency characteristic of the sound pressure can be obtained.

It should be noted that though the modification shown in FIG. 9 is a modification of the electronic device 10c according to the present embodiment shown in FIG. 7, it can be applied to any one of the electronic devices 10, 10a and 10b of the first to third embodiments.

### Fifth Embodiment

Referring to FIG. 10, an electronic device 10d according to a fifth embodiment of the present invention is a modification of the electronic device 10a according to the second embodiment and is provided with the same structure as that of the second embodiment except for a sound generating unit 50d. Accordingly, the description will be mainly made to the sound generating unit 50d in the following.

As shown in FIG. 10, the sound generating unit 50d has the piezoelectric plate 60, a supporting member 100 and a weight 70d. The supporting member 100 has a supporting portion 92d and an attached portion 94d. The supporting portion 92d and the attached portion 94d correspond to the supporting portion 92a and the attached portion 94a in the second embodiment, respectively. That is, the supporting portion 92d covers the lower surface 64 of the piezoelectric plate 60 to support the piezoelectric plate 60 and supports the weight 70d. The attached portion 94d is attached to a mount 36d of a case 30d.

In the present embodiment, the supporting member 100 is made of a metal plate, for example, a stainless plate. The piezoelectric plate 60 and the weight 70d are fixed to the supporting member 100 using an adhesive. A double-faced tape may be used in place of the adhesive. Moreover, the attached portion 94d of the supporting member 100 has no screw hole and is joined to the mount 36d. However, similar to the second embodiment, screw holes may be formed in the attached portion 94d and the attached portion 94d may be fixed to the mount 36d with screws.

The weight 70d is aligned with the piezoelectric plate 60 in the first horizontal direction and supported by the supporting portion 92d. Hence, the weight 70d covers one, which is more far from the attached portion 94, of two end portions of the piezoelectric plate 60 in the first horizontal direction. There may be or may not be a gap between the weight 70d and the piezoelectric plate 60. A size of the weight 70d is larger than a size (thickness) of the piezoelectric plate 60 in the vertical direction. Consequently, when the sound generating unit 50d is vibrated, the piezoelectric plate 60 is prevented from hitting directly against any other member (e.g. the main surface member 20), and the piezoelectric plate 60 is prevented from damaging. Thus, in the present embodiment, the weight 70d not only functions as the weight 70 of the second embodiment but also functions as the protective portion 93. That is, in the present embodiment, the supporting member 100 and the weight 70d function as the protective member 90a of the second embodiment.

Although the weight 70d of the rectangular parallelepiped shape is used in the present embodiment, the present invention is not limited thereto. For example, as shown in FIG. 11, a weight 70e having an angular U-shape in a plan view may be used. The weight 70e has a main portion corresponding to the weight 70d and a pair of arm portions extending from the main portion in the same direction along the first horizontal direction. The arm portions of the pair are disposed to interpose the piezoelectric plate 60 between them in the horizontal plane. In other words, each of the arm portions of the pair is disposed to cover a part of either one of the two side surfaces 66 of the piezoelectric plate 60.

Although the weight 70e is formed as a single weight, the main portion and the arm portions may be formed as individual weights. In such a case, the main portion and the arm portions may be disposed apart from one another. Alternatively, the main portion may be removed and only one pair of weights corresponding to the arm portions may be used. When a plurality of weights is used, a size and a position of each of the weights can be adjusted, and adjustment of the frequency characteristics can be executed easily.

Although the specific explanation about the present invention is made above referring to the embodiments, the present invention is not limited thereto.

In the aforementioned embodiments, the protective portion 93 or 93a surrounds the plurality of the side surfaces 66 in the horizontal plane parallel to the lower surface 64. However, the present invention is not limited thereto. The protective portion 93 or 93a may cover at least one of the side surfaces 66, for example. Similarly, the weight 70d or 70e functioning as the protective portion may cover at least one of the side surfaces 66.

In the aforementioned embodiments, the protective member 90 or 90a is illustrated to be different and distinct from the case 30, 30a or 30b. However, the present invention is not limited thereto. The protective member 90 or 90a may be integrally molded with the case 30, 30a or 30b, for example. However, with consideration actual fabrication, it is desirable that the protective member 90 or 90a is different and distinct from the case 30, 30a or 30b.

The present invention is based on Japanese Patent Applications No. 2014-236679 filed on Nov. 21, 2014 and No. 2015-108493 filed on May 28, 2015, and the contents of which form a part of the present specification by reference.

While the best embodiments of the present invention have been described, as it is apparent to those skilled in the art, the embodiments are possible to be modified within a scope that is not departing from the spirit of the present invention, and such embodiments belong to the scope of the present invention.

### REFERENCE SIGNS LIST

10, 10a, 10b, 10c, 10d electronic device

20 main surface member

30, 30a, 30b, 30d case

32 bottom portion

34 sidewall portion

36a, 36d mount

38b inner structure portion

50, 50a, 50c, 50cx, 50d sound generating unit

60 piezoelectric plate

62 upper surface

64 lower surface

66 side surface

70, 70d, 70e weight

71 weight

80, 82 external electrode

84 flexible printed circuit (FPC)

86, 88 conductor

90, 90a, 90c, 90cx protective member

92, 92a, 92cx, 92d supporting portion

92c1 first end portion

92c2 second end portion

93, 93a, 93cx1, 93cx2 protective portion

94, 94a, 94d attached portion

96, 96a screw hole

97c additional vibrating portion

100 supporting member

1. A sound generating unit which is used in an electronic device provided with a main surface member used as a vibrating plate and a case supporting the main surface member, the sound generating unit which is attached to either the main surface member or the case to generate sound by vibrating the main surface member, wherein:
the sound generating unit comprises a piezoelectric plate and a protective member;
the piezoelectric plate has a longitudinal direction in a first horizontal direction and has an upper surface, a lower surface and a plurality of side surfaces;
the protective member has a supporting portion which covers the lower surface of the piezoelectric plate and which supports the piezoelectric plate, a protective portion which covers at least one of the side surfaces and an attached portion which is attached to either the main surface member or the case.

2. The sound generating unit as recited in claim 1, wherein the supporting portion and the protective portion are formed in a single body using identical material.

3. The sound generating unit as recited in claim 2, wherein:
the supporting portion supports the lower surface of the piezoelectric plate; and
the protective portion surrounds the plurality of the side surfaces in a horizontal plane parallel to the lower surface.

4. The sound generating unit as recited in claim 2, further comprising a weight, wherein the supporting portion supports the weight and the piezoelectric plate in a state that the weight and the piezoelectric plate are aligned with each other in the first horizontal direction.

5. The sound generating unit as recited in claim 1, wherein the protective portion is a weight supported by the supporting portion.

6. The sound generating unit as recited in claim 5, wherein the weight is aligned with the piezoelectric plate in the first horizontal direction.

7. The sound generating unit as recited in claim 6, wherein:
the weight has a main portion and a pair of arm portions extending from the main portion in the first horizontal direction; and
the arm portions interpose the piezoelectric plate therebetween in a horizontal plane parallel to the lower surface.

8. The sound generating unit as recited in claim 5, wherein a size of the weight is larger than a size of the piezoelectric plate in a vertical direction orthogonal to the lower surface.

9. The sound generating unit as recited in claim 1, wherein the attached portion extends from the supporting portion in a second horizontal direction orthogonal to the first horizontal direction.

10. The sound generating unit as recited in claim 9, wherein the protective member has an L-shape when seen along a vertical direction orthogonal to both of the first horizontal direction and the second horizontal direction.

11. The sound generating unit as recited in claim 9, wherein:
the supporting portion has a first end portion and a second end portion in the first horizontal direction;
the attached portion is positioned at a side of the first end portion in the first horizontal direction; and
the protective member further comprises an additional vibrating portion which further extends from the first end portion of the supporting portion in the first horizontal direction.

12. The sound generating unit as recited in claim 11, further comprising a weight positioned on the additional vibrating portion.

13. The sound generating unit as recited in claim 9, wherein the supporting portion of the protective member has an asymmetrical shape with respect to a straight line which passes through a middle of the second horizontal direction of the supporting portion and which extends in a vertical direction orthogonal to both of the first horizontal direction and the second horizontal direction.

14. The sound generating unit as recited in claim 1, wherein:
the attached portion is formed with a screw hole; and
the attached portion is screwed to either the main surface member or the case.

15. An electronic device comprising:
the sound generating unit according to claim 1;
the main surface member; and
the case,
wherein the sound generating unit is attached to either the main surface member or the case.

16. The electronic device as recited in claim 15, wherein:
the case has a bottom portion and a sidewall portion which extends upward from the bottom portion and which supports the main surface member; and
the attached portion is attached to the sidewall portion.

17. The electronic device as recited in claim 15, wherein:
the case has a bottom portion, a sidewall portion which extends upward from the bottom portion and which supports the main surface member and a mount which protrudes upward from the bottom portion at a position apart from the sidewall portion; and
the attached portion is attached to the mount.

18. The electronic device as recited in claim 15, wherein:
the case has a bottom portion, a sidewall portion which extends upward from the bottom portion and which supports the main surface member and an inner structure portion which is connected to the bottom portion and the sidewall portion; and
the attached portion is attached to the inner structure portion.
